(19) United States
(12) Patent Application Publication
(10) Pub. No.: US 2023/0285919 A1
(43) Pub. Date: Sep. 14, 2023

(54) GAS-PROCESSING SYSTEMS AND METHODS

(71) Applicant: ENTEGRIS, INC., Billerica, MA (US)

(72) Inventors: Peter K. Shogren, Nipomo, CA (US); Matthew Schlotterbeck, Atascadero, CA (US); Charles H. Applegarth, San Luis Obispo, CA (US)

(21) Appl. No.: 18/120,283

(22) Filed: Mar. 10, 2023

Related U.S. Application Data
(60) Provisional application No. 63/318,894, filed on Mar. 11, 2022.

(51) Int. Cl. B01J 8/02; B01D 53/04

(52) U.S. Cl. CPC B01J 8/0278; B01J 8/025; B01J 8/0285; B01D 53/0438; B01D 2257/102; B01D 2257/502; B01D 2257/7025; B01J 2208/0053; B01J 2208/00176; B01J 2208/00221; B01J 2208/00194

(57) ABSTRACT

Described are gas-processing systems that include a media vessel and a pre-heater, that are used to process a gas by flowing the gas to contact media contained in the media vessel, such as a catalyst or adsorbent material, and related methods.

### FIELD

The disclosure relates to gas-processing systems that include a media vessel and a pre-heater, that are used to process a gas by flowing the gas to contact media contained in the media vessel, such as a catalyst or adsorbent material, and related methods.

### BACKGROUND

Industrial gases are used as raw materials or as processing materials (referred to as “reagent gases”) for many different commercial and industrial purposes, including for manufacturing semiconductor and microelectronic devices.

To prepare the reagent gas for use in a process, the gas may be handled or treated to cause any of a variety of different effects on the gas. The reagent gas may be heated, cooled, purified, filtered, processed catalytically, etc.

Gas purification systems are adapted to supply a consistent flow of a purified reagent gas to a piece of manufacturing equipment such as a semiconductor or microelectronic processing tool. Example reagent gases include: nitrogen, argon, helium, hydrogen, carbon dioxide, clean dry air (“CDA”), and oxygen, each in a purified form.

Techniques for purifying a flow of a gas can involve contacting the gas with a media material that can remove (i.e., reduce) an amount of impurity that is contained in the gas. By some techniques an impurity is removed from a flow of gas by sequestering the impurity, such as by causing the impurity to become adsorbed on a surface of an adsorbent (i.e., “adsorption media”). By other techniques an impurity may be contacted with a solid catalyst material that chemically converts (e.g., oxidized) the impurity into derivative compounds that are considered more desirable—or less undesirable—compared to the original impurity.

Manufacturers have designed highly specialized equipment for performing gas purification processes. Systems for purifying a gas will include a container (vessel) that holds a type of media (e.g., a purification media) such as an adsorbent, filter, or catalyst, and appurtenant flow control equipment that directs a flow of a reagent gas through the vessel to contact the media. Controls are included to control conditions of the process such as temperature, pressure, and flow rates.

Many gas processing systems include a gas pre-heater that is used to pre-heat a gas before the gas is flowed through a vessel that contains media. For example, to improve efficiency of a catalytic purification process, a gas may be pre-heated before contacting a catalyst. Equipment for these types of catalytic processes includes a vessel that contains the catalyst, flow controls to cause a flow of the gas through the catalyst, and a pre-heater that heats the gas to an elevated temperature before the gas contacts the catalyst.

A gas pre-heater may also be useful in adsorption-type gas purification systems, either in an adsorption (for filtering or purification) step or for a regeneration step. In these systems, purification by adsorption is performed by flowing a gas to contact adsorption media. Flowing the gas through the adsorption media causes impurities in the gas to become adsorbed onto the adsorption media while the gas is not adsorbed and passes through the media.

Over a period of use adsorbing impurities, the impurities accumulate on the adsorption media. Accumulated impurities may be removed from the adsorbent by a regeneration process, which exposes the media to a flow of a clean (“regeneration”) gas, at elevated temperature, to cause the impurities to be desorbed and be removed from the adsorbent. A regeneration process may be performed with the adsorption media remaining in the same vessel that contained the media during the purification step, by passing heated gas (“regeneration gas”) through the adsorption media in the original vessel. The regeneration gas contacts surfaces of the adsorption media and adsorbed impurities that have accumulated on surfaces of the media will desorb from the surfaces to be carried away from the adsorption media by the regeneration gas. For efficient regeneration, the regeneration gas is normally pre-heated before contacting the adsorption media.

For any types of process step, media, and reagent gas (which includes a regeneration gas), e.g., in a catalytic process, adsorbent process, filtering process, purification process, or regeneration process, etc., the process may include a heated gas passing through a bed of heated media, with uniform temperature distribution throughout the gas and passing through media. Preferably, a vessel that contains the media with the gas flowing through the media will be controlled to a desired process temperature, with the entire vessel and all locations of the vessel, gas, and media, ideally kept at a single, desired process temperature. Equipment and processes are designed to reduce or eliminate temperature gradients within a media vessel.

To control temperature of the gas and avoid thermal gradients a processing system may include a pre-heater that heats the gas before the gas contacts media contained in a media vessel. In one manner, the gas may be heated before entering the media vessel by using a separate, stand-alone pre-heater apparatus that is a separate structure from the media vessel. The gas flows first through the stand-alone pre-heater apparatus, where the gas is heated, and the heated gas then flows from the pre-heater apparatus to a separate media vessel. The separate pre-heater apparatus requires separate flow control, separate temperature and pressure controls and sensors, separate heating and insulating equipment, and completely separate physical containment structures.

Alternate pre-heating techniques involve heating a gas as the gas is contained in and passes through a space of the vessel that contains the media (the “media vessel”), at a location that is “upstream” of the media. The pre-heater is a portion of an interior space of a media vessel that also includes the media, with the pre-heater portion including a heating elements or another type of heating mechanism to add heat energy to a flow of gas as the gas passes from an inlet of the vessel, through the pre-heater space, then into contact with the media. The pre-heater space is arranged physically “in line” with media contained in the media vessel and upstream of the media, within a shared structure, and typically vertically above or vertically below the media.

### SUMMARY

For various reasons, commercial processes may include a step of contacting a gas and a media to cause the media to interact with the gas to perform an operation on the gas or to perform an operation on the media. Example processes include those that filter or purify the gas, or regenerate the media.

These types of processes may require or may be improved by operating the process at an elevated temperature by heating the gas, the media, or both. For example, processes of purifying a reagent gas by a catalytic technique are typically performed at an elevated temperature. Likewise, a process of regenerating a bed of solid adsorption media used in an adsorption-type purification or filtering process is typically performed at an elevated temperature. For these methods, the relevant gas (the reagent gas or a regeneration gas) is typically pre-heated before the gas is contacted with the relevant media (catalyst or adsorption media).

Described as follows are gas-processing apparatuses that include a combination of a media vessel with an annular pre-heater that surrounds the media vessel. Novel and inventive apparatus designs include a media vessel to contain media such as adsorbent, catalyst, or the like, and the annular pre-heater that surrounds the media vessel and is preferably in thermal contact with the media vessel. In use, a flow of gas enters into the annular pre-heater through an inlet and then flows through the annular pre-heater that surrounds the media vessel, then through a pre-heater outlet that leads to the media vessel and media. As the gas passes through the pre-heater, the pre-heater adds heat energy to the gas, and the gas that flows from the pre-heater into the media vessel has been heated by the pre-heater to an elevated temperature.

The novel design allows the pre-heater apparatus to share common structure and controls with the media vessel. In preferred examples, the pre-heater may be in thermal contact with the media vessel to share heat energy with the media vessel through adjacent or common structures of the pre-heater and media vessel, e.g., through sidewalls of the structures, in addition to heat that is exchanged by pre-heated gas that flows from the pre-heater to the media vessel. An overall effect is a reduced amount of energy being required to heat the gas and the media. The effect may be enhanced by the use of flow control structures within the volume of the pre-heater, such as baffles, to control flow of the gas between the inlet and the outlet of the pre-heater.

Another preferred feature of the apparatus may be that an exterior of the combined pre-heater and media vessel gas-processing apparatus may be insulated, but does not require and may preferably exclude a heating element as part of an insulating device (e.g., a blanket) at the apparatus exterior.

In one aspect, the disclosure relates to a gas-processing apparatus. The apparatus includes a media vessel and a pre-heater. The media vessel includes: a media vessel inlet end comprising a media vessel inlet; a media vessel outlet end comprising a media vessel outlet; a media vessel sidewall extending between the media vessel inlet and the media vessel outlet; and a media vessel interior defined by the media vessel sidewall. The pre-heater is located on an outer side of the media vessel sidewall and includes: a pre-heater sidewall that is external to the media vessel sidewall, and is spaced from the media vessel sidewall to define a pre-heater volume between an outer surface of the media vessel sidewall and an inner surface of the pre-heater sidewall; a pre-heater inlet, and a pre-heater outlet in fluid communication with the media vessel inlet.

In another aspect, the disclosure relates to a method of using a gas-processing apparatus of the present description. The method includes: flowing a gas through the pre-heater to pre-heat the gas; and passing the pre-heated gas through the media vessel interior to contact media contained in the media vessel interior.

### BRIEF DESCRIPTION OF THE DRAWINGS

FIG. 1A is a side perspective view of an exterior of an apparatus as described comprising a media vessel and pre-heater.

FIG. 1B is a top view of an exterior of an apparatus as described comprising a media vessel and pre-heater.

FIGS. 1C and 1D are side cut-away views of an apparatus as described comprising a media vessel and pre-heater.

FIG. 1E is a detailed cut-away view of an apparatus as described comprising a media vessel and pre-heater.

FIGS. 2A and 2B show an example of an apparatus with baffles as described.

All figures are schematic, illustrative, and not necessarily to scale.

### DETAILED DESCRIPTION

The following is a description of gas-processing equipment that is useful for processing a flow of gas, and that includes a pre-heater. Also described are methods of using the equipment for processing a gas by heating (“pre-heating”) the gas before a subsequent processing operation performed by contacting the flow of gas with media.

The gas-processing apparatus includes a media vessel to contain a type of processing media (e.g. adsorbent, catalyst), and an annular pre-heater that surrounds an exterior of the media vessel and pre-heats a flow of gas prior to the gas flowing into the media vessel to contact the media. The pre-heated gas contacts the media within the media vessel, which may be a solid catalyst or an adsorption media, or the like. The pre-heater is integrated into the physical structure of the media vessel in a manner that allows the pre-heater to share space and structure with the media vessel, to share heat energy with the media vessel by conductive heat transfer, or both. Preferred designs allow for heat energy to pass from the pre-heater into the media vessel by thermal conduction through structure of the pre-heater and the media vessel, particularly through sidewall structures of the pre-heater and media vessel.

Example gas-processing apparatuses include a media vessel that includes an inlet at one end, an outlet at a second end, and a length and a volume that extend between the two ends. The pre-heater is located along at least a portion of the length of the media vessel at the exterior of the media vessel. The pre-heater may be in thermal contact with the media vessel along the length of the media vessel to allow heat energy to pass by thermal conduction between the pre-heater and the media vessel. With example designs, a surface of the pre-heater along the length of the pre-heater contacts or is shared with a surface of the media vessel along the length of the media vessel. With the two surfaces being shared or in thermal contact, the combined structures may be designed with an overall reduction of physical components relative to other media vessel and pre-heater designs. As one example, an apparatus as described may include a blanket at an exterior, i.e., surrounding the pre-heater, to insulate the apparatus and retain heat within the pre-heater. Example apparatuses, however, do not require and may specifically exclude a heating element (any source of heat energy) that adds heat to the pre-heater from a location exterior to the pre-heater.

A reduced amount of physical components of a combination of media vessel pre-heater structures can allow for cost savings, may allow for a reduction in a total size (especially length) and space requirements of the media vessel and pre-heater devices, or both.

A range of different types of gas-processing operations involve contacting a gas, referred to herein as a “reagent gas” or “process gas,” with a solid material, referred to herein generically as a “media,” to perform a process operation on the gas (such as filtering or purification) or the media (e.g., regeneration of adsorption media). The media may be any of various materials, with specific examples being solid materials (i.e., as opposed to liquid or gaseous materials) that can be of a range of forms (e.g., particles, granules, etc., of solid (non-liquid, non-gaseous) pieces with a porous morphology, and of various sizes), and that may function as a catalyst, an adsorbent, or for another purpose when contacted with the gas.

For use in a gas purification process, a reagent gas that contains an impurity can be flowed to contact media, and the media can reduce the amount of the impurity in the gas during contact between the media and the gas. Purification processes include processes of filtering, adsorption of impurities from a gas, and catalytic conversion of impurities from a gas.

By some gas purification techniques an impurity is removed from a flow of process gas by sequestering the impurity, such as by causing the impurity to become adsorbed on a surface of an adsorbent material. The gas is flowed to contact the solid adsorbent material and impurities that are present in the gas are attracted to and adsorbed onto surfaces of the adsorbent to remove the impurity from the gas, which is not substantially adsorbed. A variety of adsorbent materials are known. The adsorbent can be in any of various sizes and shapes, such as small particulates, granules, pellets, shells, cubes, monoliths, etc., with a desired amount of surface area per volume.

The composition of an adsorbent material may also vary and may be selected based on a type of gas being processed, a type of impurity, a desired removal efficiency, or on other factors. Examples of adsorbents that are known to be useful to adsorb impurities from a flow of gas include: activated carbon, zeolite materials, a “metal organic framework” (MOF) adsorbent, getters such as zinc-vanadium and zinc-aluminum getters, and the like), among others.

Types of reagent gases that contain impurities, and that can be processed to reduce the level of impurity using an adsorbent include: nitrogen, argon, helium, hydrogen, ammonia, carbon dioxide, clean dry air (“CDA”), and oxygen, among others.

During use of an adsorbent-type gas purification system an amount of the impurity will accumulate on the adsorbent. The accumulated impurity may be removed from the adsorbent by a “regeneration” step and the regenerated adsorbent may be used again for purifying a flow of gas by contact with the adsorbent. In a regeneration step, a flow of a relatively clean gas (a “regeneration gas”) is passed to contact the adsorbent at an elevated temperature. The regeneration gas may be heated to the elevated temperature by use of a pre-heater, as described herein.

A regeneration gas may be any gas that is effective in a regeneration step to remove accumulated impurities from adsorption media. The composition of a regeneration gas for removing an impurity from a particular type of adsorption media depends on factors that include: the type of reagent gas that was processed using the adsorption media, the type of impurity, the type of adsorbent, etc. According to certain example systems, regeneration gases useful to remove accumulated impurities from an adsorption media that was used to remove impurities from a particular type of reagent gas (identified in parentheses) include: nitrogen/hydrogen mixture (nitrogen), argon/hydrogen mixture (argon), helium/hydrogen mixture (helium), hydrogen (hydrogen), nitrogen/hydrogen mixture (ammonia), nitrogen/hydrogen mixture (carbon dioxide), clean dry air (clean dry air), oxygen (oxygen).

By other gas purification techniques, a gas purification step may use a catalyst to reduce or remove an amount of impurity from a flow of gas. By these techniques, an impurity contained in a gas may by contacted with a solid catalyst to chemically convert (e.g., chemically reduce or chemically oxidize) the impurity compound into derivative chemical compounds that are more desirable—or less undesirable—compared to the original impurity.

The catalyst can be selected to react with a particular impurity present in a reagent gas. Example catalysts may be effective to chemically reduce nitrogen oxides (NOₓ), to oxidize carbon monoxide, or to oxidize a hydrocarbon such as methane to form water and carbon dioxide. By these techniques, a flow of reagent gas is directed to contact the media, which is a catalyst, and an impurity (e.g., a nitrogen oxide, carbon monoxide, or a hydrocarbon such as methane) is chemically converted (e.g., chemically reduced or chemically oxidized) into chemical compounds that are preferred relative to the original impurity. In the particular example of oxidizing a hydrocarbon such as methane, the hydrocarbon is catalytically oxidized to form water and carbon dioxide.

The composition of a catalyst of a gas purification process may also vary and may be selected based on a type of gas being processed, a type of impurity contained in the gas that is being processed, a desired efficiency of removal of the impurity, as well as other factors. Examples of catalysts that are known to be useful to convert impurities that are contained in a flow of gas include: rhodium, platinum, palladium, among others.

According to example gas-processing apparatus, a useful apparatus includes a media vessel that has a media vessel inlet, a media vessel outlet, a length that extends between the inlet and the outlet, and sidewalls that extend along the length and define an interior volume of the media vessel. The sidewalls can be made of a rigid, thermally conductive material such as a metal.

A “media vessel inlet” can be considered an open portion of a media vessel that is connected to (in fluid communication with) the media vessel interior, and that is part of a flow path into the media vessel interior such that a process gas that flows through the media vessel inlet flows into the media vessel interior, which contains the media. The media vessel inlet also communicates directly or indirectly with a pre-heater outlet. The media vessel inlet may connect directly to a pre-heater outlet or may connect to a pre-heater outlet through a closed flowpath between the pre-heater outlet and the media vessel inlet, such as a path that extends from the pre-heater outlet through an inlet headspace and then to the media vessel inlet.

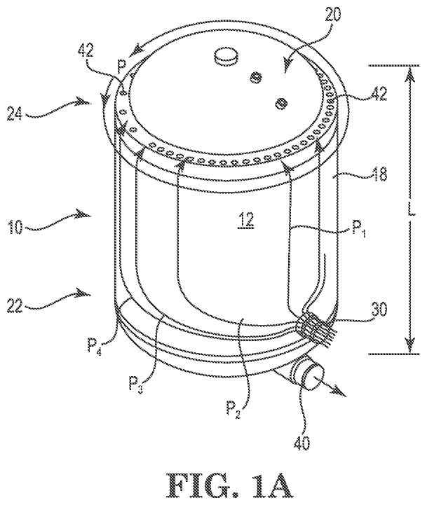

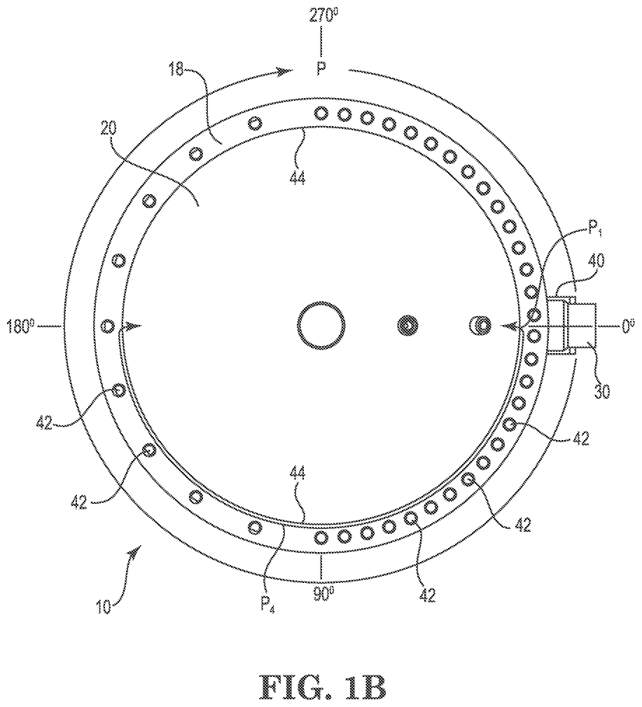

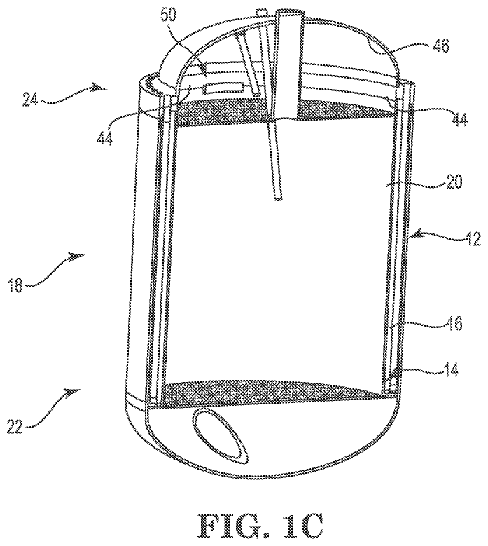

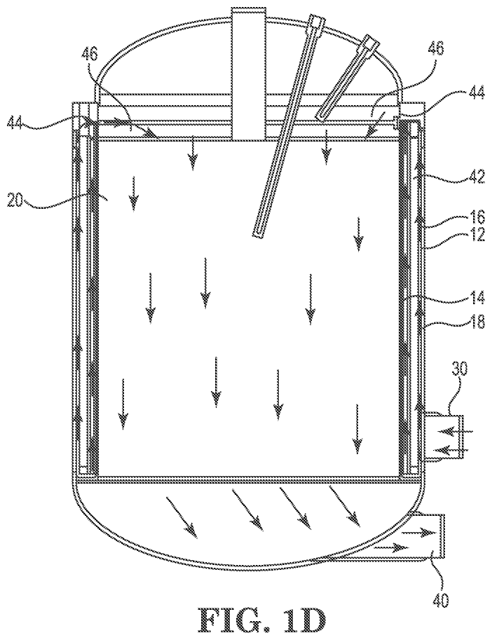

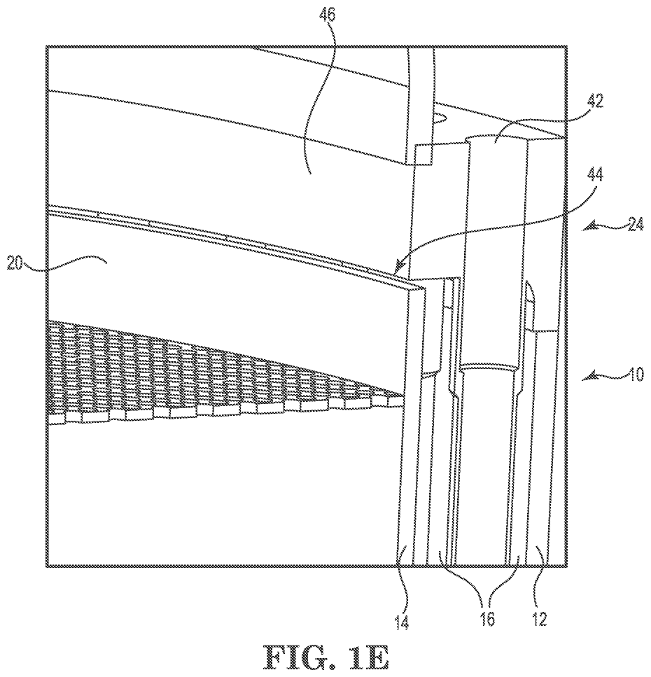

Also according to an apparatus as described, an annular pre-heater is located adjacent to an outside surface of the media vessel along at least a portion of the length of the media vessel and around an entire outer surface, i.e., circumference (perimeter), of the media vessel. A useful or preferred pre-heater can include a sidewall surface that is in thermal contact with an outer surface of the media vessel. The term “perimeter” herein refers to a closed geometric shape of a vessel, sidewall, pre-heater, or a space thereof when viewed in cross-section along the length (e.g., when viewed in a vertical direction or “height” as shown at FIG. 1), which is generally along a horizontal cross-section of a vessel, sidewall, or space of a gas processing apparatus of the present description.

A pre-heater that is “in thermal contact” with a media vessel refers to a pre-heater that includes a structure such as a sidewall that is in common with a structure of the media vessel or that is located in sufficiently close proximity to a surface (such as a sidewall) of the media vessel to allow a useful amount of thermal energy to pass from pre-heater interior to the media vessel interior. A useful amount of thermal energy may be a more than negligible amount of thermal energy passing from the pre-heater to the media vessel during use of the pre-heater to supply pre-heated gas to the media vessel.

To provide for a useful amount of thermal contact between a pre-heater and a media vessel, an example gas-processing apparatus may be constructed with a thermally-conductive surface of a sidewall of the pre-heater being in direct contact with a thermally-conductive surface of a sidewall of the media vessel. The sidewall structure of the pre-heater may be identifiable as a separate physical structure that is not a required component of the media vessel, with the two different sidewall structures being in direct physical contact with each other to allow for efficient transfer of thermal energy by thermal conduction from the surface of the pre-heater sidewall to the surface of the media vessel sidewall.

Alternately, a gas-processing apparatus as described may be constructed in a manner by which a sidewall of the media vessel and a sidewall of the pre-heater are made from a single physical structure. The single sidewall structure defines an interior of the media vessel on one side of the sidewall (the “inside” of the single sidewall), and defines an interior of the pre-heater on an opposite side of the sidewall (the “outside” of the single sidewall).

In contrast, sidewall structures of a media vessel and a pre-heater are considered to be not in thermal contact with each other if sidewall structures of the media vessel and the pre-heater are arranged in a way that does not allow a useful amount of thermal energy transfer from a sidewall of the pre-heater through a sidewall of the media vessel during a gas-processing step as described herein. Various designs of previous gas-processing systems include a pre-heater and a media vessel with the two being arranged to not allow thermal transfer between sidewall structures, i.e., with the pre-heater being not in thermal contact with the media vessel. For example, certain pre-heater designs involve pre-heating a process gas as the gas passes through a space within a media vessel that is “upstream” of the media within the same vessel, with the pre-heater space containing heating elements that transfer heat to the gas passing through the pre-heater space. The pre-heater space and heating elements are contained in a single vessel with the media, and a process gas flows through the vessel by first contacting the heating elements and then contacting the media. The in-line pre-heater is often located either above the media or below the media. Sidewall of the pre-heater structure is not considered to be in thermal contact with a sidewall structure of the media vessel.

According to novel gas-processing apparatuses of the present description, a pre-heater includes a pre-heater interior volume that extends along a length of the media vessel at an exterior of the media vessel. More specifically, the pre-heater includes an internal volume through which a gas flows during use that is annular (an “annular volume”) and that extends along an outside surface of the media vessel over at least a portion of the length of the media vessel between the media vessel inlet and the media vessel outlet.

The pre-heater includes an annular volume that is defined by an inner sidewall and an outer sidewall, the outer sidewall being spaced from the inner sidewall to produce the interior space of the pre-heater. The inner sidewall can be the same structure as, or connected to, or in thermal contact with an outer wall (sidewall) of the media vessel. The volume (interior space) between the pre-heater inner sidewall and the pre-heater outer sidewalls is nominally referred to as “annular” and is preferably cylindrical with a circular cross-section (when viewed along the length) for high efficiency of design of the apparatus; however, the “annular” cross-section may be of a non-circular shape if desired, e.g., an oval, rectangular, shape, etc.

Example pre-heaters include a pre-heater inlet at a lower portion of the pre-heater, which passes through the pre-heater outer sidewall, and a pre-heater outlet at an upper portion of the pre-heater, which passes through or past the pre-heater inner sidewall. If desired, an apparatus as described may be configured to operate with a different flow of a gas through the pre-heater and media vessel. For example, a pre-heater inlet may be at a top region of an apparatus, and a gas may flow into the inlet and then in a vertically downward direction through the pre-heater, followed by the gas flowing in a vertically upward direction through the media vessel.

According to certain example apparatuses, the pre-heater inlet includes an opening or aperture that passes through the pre-heater outer sidewall on one side of the pre-heater, and does not extend over more than a minor portion of the length of the perimeter of the pre-heater; this means, for example, that the inlet does not extend from a front to a back of the pre-heater, as the pre-heater outlet does, but may extend over only a short length of the perimeter of the pre-heater, such as a portion of the perimeter that is less than 3025 or 20 degrees of the 360 degrees around the perimeter. The inlet has an area defined by the size (area) of the opening through the pre-heater exterior sidewall, e.g., an area of a circular opening.

The inlet can be any form of opening through the pre-heater exterior sidewall that allows gas to flow from an exterior location, through the inlet opening in the pre-heater exterior sidewall, and into the pre-heater interior. The inlet may be round, and may include a tubular flow conduit such as a circular pipe or tube that enters the interior through the opening to allow gas to flow from an exterior location to the pre-heater interior.

The pre-heater outlet is located at an end of the apparatus that is opposite from the location of the pre-heater inlet, and also extends around a significant portion of the length of the perimeter of the annular pre-heater between a front of the apparatus and a back of the apparatus; the outlet extends along at least a portion of the front of the pre-heater (the front 180 degrees, from 90 degrees to 270 degrees, including the front at 0 degrees, see FIG. 1B), and also extends along at least a portion of the back of the pre-heater (the back 180 degrees, from 90 to 270 degrees, including the back at 180 degrees, see FIG. 1B). The location of the outlet around a significant portion of the length of the perimeter of the annular pre-heater allows gas to flow from most or all portions of the annular pre-heater, into the media vessel. The location along the length of the perimeter allows pre-heated gas to enter the media vessel from all or substantially directions about the perimeter of the media vessel (e.g., from around the entire 360 degrees of the annular pre-heater).

The outlet extends along the length of the media vessel inner sidewall as a horizontal opening that may be referred to as a horizontal flow gap, a horizontal space, a horizontal slot, that has a length along the perimeter or the pre-heater inner sidewall, along the media vessel sidewall, or both. The outlet opening may along the length be continuous (i.e., extend the entire 360 degree perimeter un-interrupted), segmented (e.g., include multiple regular interruptions), or may be otherwise interrupted, such as to reduce an amount of flow at a location using a baffle that blocks flow through the outlet. Different from the pre-heater inlet, the outlet opening includes an opening to allow gas to flow out of the pre-heater over a substantial range of locations along the 360 degree perimeter of the pre-heater, including, optionally, at or near a front, at a back, and at locations between the front and the back.

The outlet also has an area that is equal to the size of the opening between the pre-heater interior and the media vessel interior. The opening may be an area equal to a size of a flow gap, meaning a length of a flow gap about a perimeter of a media vessel sidewall (exclusive of interruptions or baffles) multiplied by a “height” of the flow gas (which is the dimension of the flow gap along the “length” of the media vessel).

According to preferred examples, an apparatus can have a desired ratio of the area of the pre-heater inlet to the media vessel outlet (designated as 30 and 40, respectively, at FIG. 1). Example ratios of the area of the pre-heater inlet to the media vessel outlet may be from 2:1 to 1:2, e.g., from 1.5:1 to 1:1.5 (area of the pre-heater inlet: area of the media vessel outlet). In example systems, the area of the media vessel outlet may be slightly larger than the area of the pre-heater inlet, for example the media vessel outlet may have an area that is equal to the area of the pre-heater inlet, or may have an area that is between 100 percent and 150 percent the size of the pre-heater inlet, or between 110 percent and 130 percent the size of the pre-heater inlet

The pre-heater contains a source of heat, referred to as “heating elements,” which during use are operated at an elevated temperature relative to a process gas that enters the pre-heater through the pre-heater inlet. The heating elements transfer heat energy to the gas that flows through the pre-heater interior to raise the temperature of the gas before the gas exits the pre-heater at the pre-heater outlet and enters the media vessel. The temperature of the heating elements may be controlled, e.g., elevated, by any useful source or method, such as electric resistive heating, or by a fluid that circulates through the heating element, for example hot water, steam, or a different fluid that can transfer heat energy to a fluid passing through the pre-heater. The heating element may be of any useful design, including heating elements sometimes referred to as heating rods, electrical resistance heaters, heating bars, strip heaters, etc.

The heating elements may be distributed uniformly within the pre-heater about a perimeter of the annular pre-heater interior, or may instead be distributed non-uniformly within the interior about the circumference of the pre-heater. One example of a heating element is a heating rod, which can be placed within the annular interior space of the pre-heater. In particular example apparatuses, the heating rods can be distributed in a non-uniform fashion around the perimeter of the annular pre-heater interior.

As a result of the pre-heater inlet being located along a limited portion of the pre-heater perimeter (e.g., at only a front location of the pre-heater), compared to the pre-heater outlet being located about a large range of the pre-heater perimeter, gas that flows into the annular pre-heater will pass from the inlet to the outlet over a range of flow paths within the annular pre-heater interior. Various flowpaths will extend different distances around the length of the pre-heater perimeter to allow the gas to exit the front, sides, and back of the pre-heater outlet to cause gas to enter the media vessel from all portions of the perimeter of the media vessel.

The different flow paths between the reduced-length (relative to the perimeter) inlet at the front of the pre-heater, and the range of outlet locations around the front, back, and sides of the perimeter of the pre-heater, have different flowpath lengths and, therefore, different residence times within the pre-heater.

For example, a flow of gas that passes through the inlet into the annular pre-heater interior at a front side of the pre-heater may flow out of the pre-heater outlet (into a media vessel) also at the front side. The gas that travels this flowpath through the pre-heater interior travels a shortest possible distance between the inlet and the outlet. This flowpath of gas through the pre-heater will also have a shortest possible residence time in the interior of the pre-heater.

In contrast, flow of gas that enters the inlet at a front side of the annular pre-heater interior and flows out of the outlet at the back of the pre-heater (and media vessel), 180 degrees around the circumference of the pre-heater relative to the inlet, travels as far as possible from the inlet to reach the outlet at the back of the pre-heater. The gas that travels this flowpath travels a largest possible distance between the inlet and the outlet. This flow of gas will have a longest possible residence time in the annular space of the pre-heater.

Gas that travels along a longer flowpath has a higher residence time in the pre-heater interior, and gas that travels along a shorter flowpath has a lower residence time in the pre-heater interior. In a pre-heater that includes heating elements that are evenly distributed within the pre-heater around a perimeter of the pre-heater, the difference in residence times can cause a disparity or un-evenness in temperature of gas that exits the pre-heater at different locations along the perimeter of the pre-heater outlet. With heating elements being evenly-distributed about a circumference of a pre-heater, gas that has a longer residence time within the pre-heater would be subject to a higher amount of heat transfer from the heating elements as the gas flows through the pre-heater from the inlet to the outlet, and will absorb a higher amount of heat from heating elements compared to gas that has a shorter residence time within the pre-heater.

According to example methods and apparatuses of the present description, heating elements within a pre-heater may be designed and distributed to transfer different amounts of heat to gas that flows through a pre-heater along different flowpaths and experiences different residence times in the pre-heater. The pre-heater is capable of a higher rate of heat transfer to gas that flows along a shorter flowpath, and a lower rate of heat transfer to gas that flows along a longer flowpath.

As one example, heating elements may be distributed in a pre-heater in a non-uniform manner, e.g., non-uniformly (such as by varied spacings between heating elements) about the circumference of the pre-heater. Desirably, with non-uniform distribution of heating elements, gasflows along different flowpaths through the pre-heater and having different residence times within the pre-heater are exposed to different amounts of heating.

In alternate embodiments, instead of, or in addition to, distributing heating elements in a non-uniform manner within a pre-heater, heating elements may otherwise be designed or controlled to cause varied, non-uniform amounts of heat transfer to gas that flows along different flowpaths and experiences different residence time in the pre-heater. According to other examples, heating elements within a pre-heater may have different sizes (diameters, lengths) or may be set to different temperatures to cause different amounts of heat transfer to gases that travel along a longer or shorter flowpath through a pre-heater.

In these and other embodiments, a pre-heater may optionally include a flow control or a flow restrictor (e.g., a baffle) that impedes flow of gas through the pre-heater to reduce the speed or volume of fluid through a flowpath to increase the residence time for gas along that flowpath. The flow control may be, for example, a baffle located at a pre-heater outlet at a front side of the pre-heater, to cause a reduced flow rate of gas that flows through the front of the pre-heater (e.g., flowpath p1, see below) and an increased residence time of the gas that flows through the front of the pre-heater.

The different amounts (e.g., rates) of heat transfer to flows of gases that travel through longer and shorter flowpaths, and having longer and shorter residence times, can be designed to reduce the difference in temperature of gas that exits different locations of the perimeter of the pre-heater outlet and enters the media vessel at different locations around the perimeter of the media vessel inlet. Desirably, flows of gas that travel along different flowpaths can be exposed to a similar (preferably substantially equal) amount of heat transfer along each different flowpath. The flows of gas that travel along the different flowpaths may be exposed to similar amounts of heat transfer from non-uniformly-distributed heating elements to cause the different flows of gas to absorb approximately the same amount of heat energy within the pre-heater, and to exit the pre-heater through the pre-heater outlet at similar temperatures. To cause the same amount of heat energy transfer over the longer and the shorter flow paths, the rate of heat transfer can be higher along the shorter flowpaths and lower along the longer flowpaths.

An example apparatus is shown at FIGS. 1A (side-perspective view), 1B (top view), and 1C (cut-away view), 1D (detailed cut-away view), and 1E (side cut-away view). FIG. 1A-1D shows an example apparatus that includes an annular pre-heater space at an exterior of a media vessel. The pre-heater includes an inlet at only a front, and an outlet into a media vessel that extends around the perimeter of the media vessel, including portions at both the front and the back. The pre-heater interior contains heating elements arranged asymmetrically around the perimeter of the pre-heater, with more heating rods at a front of the apparatus and fewer heating rods at the back of the apparatus. A partial baffle reduces flow through the pre-heater outlet through the front of the outlet.

Referring to FIG. 1A, illustrated is the exterior of gas-processing apparatus 10. Apparatus 10 includes at an interior a media vessel 20 that is adapted to contain media (not shown). Pre-heater 18 is a structure that surrounds media vessel 20 along a length (a vertical length, as shown) of media vessel 20 from a lower portion 22 to an upper portion 24. Pre-heater 18 includes outer pre-heater sidewall 12, inner pre-heater sidewall 14 (not shown at FIG. 1A) spaced from outer pre-heater sidewall 12, and annular pre-heater interior 16 that is formed between an inward surface of outer sidewall 12 and an outward surface of inner sidewall 14. Inner sidewall 14 of per-heater 18 can also function as the sidewall (outer sidewall) of media vessel 20.

Heating elements (e.g., heating rods) 42 extend vertically from a top of annular pre-heater interior 16, into interior 16. As illustrated, all heating elements may be of the same size, construction, and heat transfer properties. In alternate embodiments, the heating elements may vary in size (length or diameter).

Apparatus 10 has a perimeter (P) and a perimeter length that is measured about the outside of apparatus 10. Inlet 30 is a round opening through outer sidewall 12 that contains a closed conduit (e.g., pipe or tube) that connects the exterior of apparatus 10 to annular interior 16 of annular pre-heater 18, and may be considered to be located at a “front” of apparatus 10.

In use, gas enters inlet 30 and passes through annular interior 16 of pre-heater 18, then through outlet 44 (not contacting shown at FIG. 1A) of pre-heater 30 and into media vessel 20. The gas flows through media vessel 20, media that is contained within media vessel 20, then passes from media vessel 20 through pre-heater outlet 44, which extends around a perimeter of pre-heater 18 at an upper portion or upper end of pre-heater 18.

The gas flows through annular interior 16 of pre-heater 18 along multiple flowpaths (e.g., p1, p2, p3, p4, shown at FIG. 1A) of different lengths. A flowpath p1 extends from inlet 30 directly up in a vertical direction (as illustrated) and passes through pre-heater outlet 44 at a top end of pre-heater interior 16. This flowpath p1 is a flowpath of minimum length between inlet 30 and pre-heater outlet 44. Gas that flows along flowpath p1 has a minimum residence time within pre-heater interior 18.

Flowpath p4 is illustrated to extend from inlet 30 along a curved path within the annular pre-heater interior to a back side of apparatus 10, which is 180 degrees opposite of the front side and inlet 30. The curved flowpath p4 extends from inlet 30 in a curved, vertical direction including along a length along the annular interior of pre-heater 18 that extends along 180 degrees of the annular interior perimeter. Flowpath p4 ends at a pre-heater outlet on the back of apparatus 10, and is of a maximum flowpath length between inlet 30 and the pre-heater outlet. Gas that flows along flowpath p4 has a maximum residence time within pre-heater 18.

Flowpaths p2 and p3 are of intermediate curved lengths between inlet 30 and pre-heater outlet, and exit pre-heater interior 16 through outlet 44 at sides of pre-heater 18 between the frontside and the backside. Gas that flows along flowpaths p2 and p3 experiences intermediate residence times relative to the maximum and minimum residence times of gas that flows through flowpaths p4 and p1.

FIG. 1B shows a top view of apparatus 10. This figure shows that heating elements 42 are distributed non-uniformly within annular pre-heater interior 16 around the length of perimeter P. Along the length of the front half of pre-heater 18, between locations of 90 degrees and 270 degrees and including the front location of 0 degrees along the perimeter, heating elements 42 are distributed at a first concentration with relatively small separation between adjacent heating elements. At the back half of pre-heater 18, between locations of 90 and 270 degrees and including the back location of 180 degrees, the concentration of heating elements 42 is reduced and the spacings between heating elements 42 are larger.

With all heating elements 42 being of the same construction, dimensions (diameter, length) and operating at the same temperature, each is capable of identical heat transfer properties relative to a gas that flows in contact with the heating element. When gas flows through pre-heater interior 16 through a longer flowpath toward the back of apparatus 10, e.g., taking flowpath p3 or p4, the gas has a longer residence time in the pre-heater. The gas contacts the heating elements 42 at the front half, having a higher concentration of heating elements, and also contacts the heating elements 42 at the back half or pre-heater 18, having a lower concentration of heating elements. In the back half of pre-heater 18, the lower concentration of heating elements transfers a lower amount of heat energy to the gas compared to the amount of heat energy transferred to the gas in the front half of pre-heater 18.

In the illustrated design, and also more generally, in an apparatus that includes heating rods as heating elements, the number of heating rods included at the interior of the pre-heater can be any useful number. Example apparatuses may include from 10 to 60 individual heating rods distributed evenly or un-evenly about the perimeter of the pre-heater interior, e.g., from 40 to 50 heating rods distributed evenly or un-evenly about the perimeter of the pre-heater interior.

Referring to FIGS. 1C (cut-away perspective view), 1D (cut-away side view), and 1E (cut-away detail), interior of apparatus 10 is shown, as well as details of annular pre-heater interior 16 between inner pre-heater sidewall 14 (also a sidewall of media vessel 20) and outer pre-heater sidewall 12.

As shown at FIG. 1D, gas flows through inlet 30, into pre-heater interior 16 at a front of apparatus 10. The gas flows through pre-heater interior and contacts heating elements 42 distributed un-evenly about the perimeter of interior 16. Reaching a top of pre-heater interior 16 the gas passes through horizontal pre-heater outlet (flow gap) 44, then enters headspace 46 from a range of positions around the perimeter of outlet 44 and media vessel 20. The gas flows through the interior volume of media vessel 20, contacts media (not shown) contained in media vessel 20, and exits media vessel 20 through outlet 40.

The amount of heat transfer to a gas along different flowpaths varies due to the different spacings of heating elements 42 at the front half of pre-heater interior 16 relative to the back half of pre-heater interior 16. Additionally or alternately, the amount of heat transfer to gas along different flowpaths may also be affected by one or more structures that affect the residence time of gas through different flowpaths, e.g., by retarding, hindering, or otherwise slowing the rate of flow of gas along a shorter flow path compared to a rate of flow along longer flowpaths. As shown at FIG. 1C, a baffle 50 is placed within pre-heater outlet 44 to prevent flow through a front segment of the length of pre-heater outlet 44 at a front of apparatus 10.

As illustrated, apparatus 10 does not include an insulating blanket at the exterior of pre-heater 18. Optionally, an insulating blanket may be included at the exterior of pre-heater 18 to retain heat within pre-heater 18. Optionally, a heating blanket may include a heating element to add heat to pre-heater 18, but apparatus 10 may not require and may exclude a heating element as part of a heating blanket, or otherwise, at the exterior of pre-heater 18, to add heat to pre-heater 18.

Also as illustrated, apparatus 10 does not include any form of heating element present within media vessel 20, i.e., at a location of media, to directly heat the a type of media (catalyst, adsorption media, or the like), or within headspace 46. According to useful or preferred examples, apparatus 10 does not require and may specifically exclude any form of heating element present within media vessel 20, e.g., at a location of media, to directly heat the media, or within headspace 46.

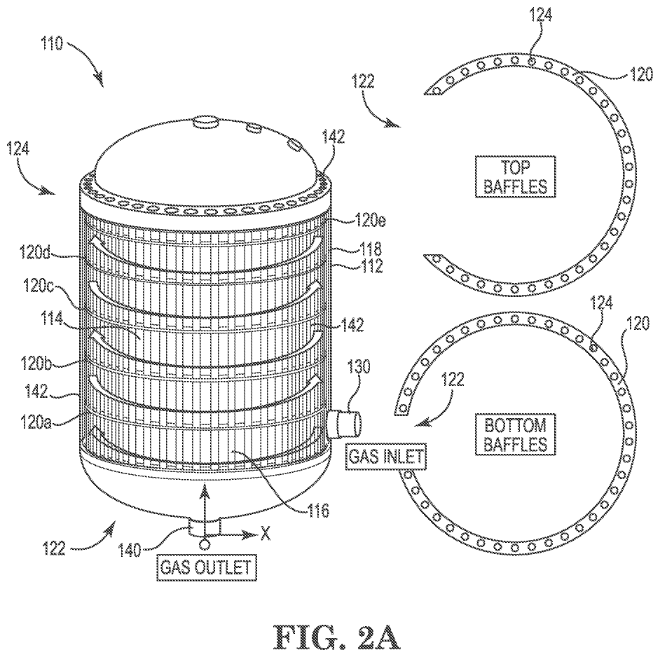

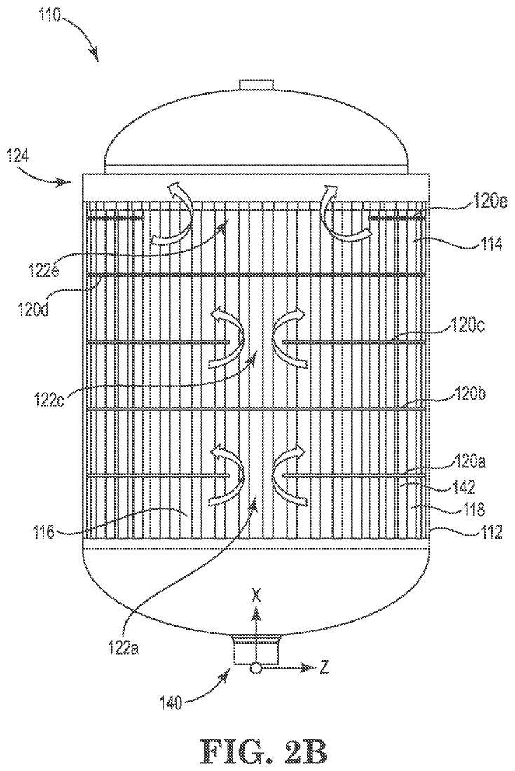

Referring to FIG. 2A, illustrated is gas-processing apparatus 110, in a side cut-away view that does not show an outer pre-heater sidewall on the viewed side of apparatus 110. Apparatus 110 includes at an interior a media vessel (not shown) that is adapted to contain media, and pre-heater 118. Pre-heater 118 surrounds the media vessel along a length (a vertical length, as shown) of the media vessel from a lower portion 122 to an upper portion 124. Pre-heater 118 includes outer pre-heater sidewall 112 (not shown in part), inner pre-heater sidewall 114, spaced from outer pre-heater sidewall 112, and annular pre-heater interior 116 that is formed between an inward surface of outer sidewall 112 and an outward surface of inner sidewall 114. Inner sidewall 114 of pre-heater 118 can also function as the sidewall (outer sidewall) of the media vessel that is surrounded by pre-heater 118.

Heating elements (e.g., heating rods) 142 extend vertically from a top of annular pre-heater interior 116, into interior 116. As illustrated, all heating elements may be of the same size, construction, heat transfer properties, and are spaced uniformly around the perimeter of interior 116. In alternate embodiments, heating elements may vary in size (length or diameter), temperature, heat transfer properties, and may be distributed in a non-uniform fashion around the perimeter of interior 116.

Apparatus 110 is an example of an apparatus that includes baffles as a manner to control a flow of gas through a pre-heater interior, between a pre-heater inlet 130 and a pre-heater outlet. The pre-heater outlet is located at the top of pre-heater interior 116 and leads to the interior of the media vessel (not shown), but is not specifically shown at FIGS. 2A or 2B.

Baffles 120 are partial-circular inserts that can fit with interior 116 between inner sidewall 114 and outer sidewall 116, at a location about a portion of the perimeter of interior 116. As included within interior 116, baffles 120 contact gas that flows through interior 116 and divert or otherwise control or affect the flow of the gas along a flowpath through interior 1160, between the pre-heater inlet and the pre-heater outlet.

As shown, apparatus 110 includes multiple (five) baffles 120 that are each positioned at a different vertical level within interior 116. Along the partially-circular length of each baffle, the baffle has a width that fits between the gap space between the inner surface of outer sidewall 112 and the outer surface of inner sidewall 114 of pre-heater 118. When positioned within pre-heater interior 116, each baffle 120 blocks a flow of gas in a vertical direction along the partially circular length. The baffle causes the gas to flow laterally in a direction around the perimeter of pre-heater 118, and prevents vertical movement of the gas at the location of the baffle.

Each baffle 120 defines a gap 122 between the ends of the baffle. When the baffle is located within interior 116, gas that is prevented from flowing vertically by a baffle 120 is allowed to flow vertically through the gap 122 between the ends of the baffle. Each baffle 120 also includes a series of apertures 124 within which heating rods 142 can be positioned when the baffles and the heating rods are installed within interior 116.

As shown at FIG. 2A, gas that enters through pre-heater inlet 130 at a front of apparatus 110 is directed by a first baffle 120a to flow from the front of pre-heater interior 116 to the back of pre-heater interior 116 (see the lowest arrow). At the back of interior 116, the lowest baffle, 120a, defines a gap between ends of baffle 120a that allows the gas to flow vertically. A second baffle, 120b, again blocks the vertical flow of the gas, at a higher vertical level, and causes the gas to flow back toward the front of interior 116. A gap between ends of the second baffle, 120b, at the front of interior 116, allows the gas to flow to a higher vertical position. Three additional baffles, 120c, 120d, and 120e, are positioned with gaps that are staggered between front and back positions within interior 116. The arrangement causes front-to back-to-front-to-back, etc., flow of gas through interior 116 as the gas flows vertically from inlet 130 at the lower portion 122 of pre-heater 118, to a pre-heater outlet (not shown) at the upper portion 124 of pre-heater 118.

FIG. 2B shows a back side cut-away view of apparatus 110, showing baffles 120a, 120b, 120c, 120d, and 120e and heating rods 142 installed in interior 116. Referring to FIG. 2B, baffles 120a, 120b, 120c, 120d, and 120e are shown in vertically ordered positions, with gaps 122a, 122c, and 122e located at the rear of interior 116. Gas flows in the direction of the arrows from the lower portion of interior 116, with vertical flow limited along the way by each baffle, and by vertical flow allowed at the rear of interior 116 through gaps 122a, 122c, and 122e. The baffles cause a flow of gas through interior 116 that is substantially equal on both sides (left and right as illustrated) of the interior 116.

1. A gas-processing apparatus comprising:
a media vessel comprising:
a media vessel inlet end comprising a media vessel inlet,
a media vessel outlet end comprising a media vessel outlet,
a media vessel sidewall extending between the media vessel inlet and the media vessel outlet, and
a media vessel interior defined by the media vessel sidewall, and
a pre-heater on an outer side of the media vessel sidewall, the pre-heater comprising:
a pre-heater sidewall that is external to the media vessel sidewall, and is spaced from the media vessel sidewall to define a pre-heater volume between an outer surface of the media vessel sidewall and an inner surface of the pre-heater sidewall,
a pre-heater inlet, and
a pre-heater outlet in fluid communication with the media vessel inlet.

2. The apparatus of claim 1, further comprising heating elements within the pre-heater volume.

3. The apparatus of claim 2, wherein the heating elements are heating rods, wherein:
the heating rods extend vertically within the pre-heater volume, and
the heating rods are distributed along a perimeter of the pre-heater volume.

4. The apparatus of claim 3, wherein the heating rods are distributed along the perimeter with non-uniform spacings between heating rods.

5. The apparatus of claim 3, wherein:
a perimeter of the pre-heater volume has a perimeter length that includes a front-half perimeter length and a back-half perimeter length,
the pre-heater inlet is located centered at the front-half perimeter length,
a front-half group of heating rods is distributed along the front-half perimeter length,
a back-half group of heating rods is distributed along the back-half perimeter length, and
the front-half group has a greater number of heating rods than the back-half group.

6. The apparatus of claim 1, further comprising at least one horizontally-extending baffle positioned at within the pre-heater volume.

7. The apparatus of claim 6, wherein the baffle has a partially-circular shape and defines a gap between two ends of the baffle.

8. The apparatus of claim 6, further comprising heating rods, wherein:
the heating rods extend vertically within the pre-heater volume,
the heating rods extend through apertures in the baffle, and
the heating rods are distributed along a perimeter of the pre-heater volume.

9. The apparatus of claim 8, wherein the heating rods are distributed along the perimeter with uniform spacings between heating rods.

10. The apparatus of claim 1, wherein the pre-heater comprises:
a pre-heater inlet end adjacent to the media vessel outlet end, and
a pre-heater outlet end adjacent to the media vessel inlet end,
wherein:
the pre-heater inlet is located at the pre-heater inlet end, and
the pre-heater outlet is located at the pre-heater outlet end.

11. The apparatus of claim 10, wherein the pre-heater outlet comprises an opening that connects the pre-heater interior with the media vessel interior, and that extends along a length of a perimeter of the pre-heater including on a front side of the pre-heater and on a back side of the pre-heater.

12. The apparatus of claim 10, wherein the pre-heater inlet is an opening on a front side of the pre-heater and extends less than 30 degrees of a length of the perimeter of the pre-heater.

13. The apparatus of claim 10, wherein the ratio of the area of the pre-heater inlet to the area of the media vessel outlet is from 2:1 to 1:2.

14. The apparatus of claim 1, wherein the pre-heater volume has a cylindrical, annular cross-section.

15. The apparatus of claim 1, wherein the media vessel containing media that comprises adsorption media or catalyst.

16. The apparatus of claim 1, further comprising an inlet end headspace that connects the media vessel inlet and the pre-heater outlet, and comprises a flow path from the pre-heater outlet, through the inlet end headspace, to the media vessel inlet.

17. The apparatus of claim 1, wherein:
the pre-heater volume comprises flowpaths of different lengths between the pre-heater inlet and the pre-heater outlet, and
the pre-heater is capable of a higher rate of heat transfer to gas that flows along a shorter flowpath compared to a lower rate of heat transfer to gas that flows along a longer flowpath.

18. A method of using a gas-processing apparatus of claim 1, the method comprising:
flowing a gas through the pre-heater to pre-heat the gas, and
passing the pre-heated gas through the media vessel interior to contact media contained in the media vessel interior.

19. The method of claim 18, wherein the gas is selected from nitrogen, argon, hydrogen, ammonia, carbon dioxide, clean dry air, and oxygen.

20. The method of claim 19, wherein:
the media comprises catalyst and the gas is a reagent gas selected from nitrogen, argon, hydrogen, carbon dioxide, clean dry air, and oxygen, and wherein the impurity is a nitrogen oxide, carbon monoxide, a hydrocarbon, or methane.

21-23. (canceled)
